(19) United States
(12) Patent Application Publication
(10) Pub. No.: US 2023/0368103 A1
(43) Pub. Date: Nov. 16, 2023

(54) KNOWLEDGE GRAPH ENABLED AUGMENTATION OF NATURAL LANGUAGE PROCESSING APPLICATIONS

(71) Applicant: SAP SE, Waldorf (DE)

(72) Inventors: Pascal Hugelmann, Baden-Wuerttemberg (DE); Steffen Terheiden, Mannheim (DE)

(21) Appl. No.: 17/742,061

(22) Filed: May 11, 2022

(51) Int. Cl. G06Q 10/06; G06F 40/186; G06F 40/174; G06F 40/279; G06F 40/205

(52) U.S. Cl. CPC G06Q 10/0633; G06F 40/186; G06F 40/174; G06F 40/279; G06F 40/205

(57) ABSTRACT

A method may include receiving a natural language command invoking a workflow of an enterprise software application. The natural language command may be parsed to identify at a first entity associated with a first value included in the natural language command. A second entity related to the first entity may be determined based on a knowledge graph representative of an ontology associated with the enterprise software application. In the event a second value associated with the second entity is absent from the natural language command, a request for the second value may be generated. Upon receiving the second value, a request for the enterprise software application execute the workflow based at least on the first value of the first entity and a second value of the second entity may be generated. Related methods and articles of manufacture are also disclosed.

### FIELD

The present disclosure generally relates to natural language processing and more specifically to augmenting natural language processing applications with knowledge graphs.

### BACKGROUND

An enterprise may rely on a suite of enterprise software applications for sourcing, procurement, supply chain management, invoicing, and payment. These enterprise software applications may provide a variety of data processing functionalities including, for example, billing, invoicing, procurement, payroll, time and attendance management, recruiting and onboarding, learning and development, performance and compensation, workforce planning, and/or the like. Data associated with multiple enterprise software applications may be stored in a common database in order to enable a seamless integration between different enterprise software applications. For example, an enterprise resource planning (ERP) application may access one or more records stored in the database in order to track resources, such as cash, raw materials, and production capacity, and the status of various commitments such as purchase order and payroll. In the event the enterprise interacts with large and evolving roster of external vendors, the enterprise resource planning (ERP) application may be integrated with a supplier lifecycle management (SLM) application configured to perform one or more of supplier identification, selection and segmentation, onboarding, performance management, information management, risk management, relationship management, and offboarding.

### SUMMARY

Methods, systems, and articles of manufacture, including computer program products, are provided for natural language processing augmented with knowledge graph. In one aspect, there is provided a system. The system may include at least one data processor and at least one memory. The at least one memory may store instructions that result in operations when executed by the at least one data processor. The operations may include: in response to receiving a natural language command invoking a workflow of an enterprise software application, parsing the natural language command to identify at a first entity associated with a first value included in the natural language command; determining, based at least on a knowledge graph representative of an ontology associated with the enterprise software application, a second entity related to the first entity; and generating a first request for the enterprise software application execute the workflow based at least on the first value of the first entity and a second value of the second entity.

In some variations, one or more of the features disclosed herein including the following features can optionally be included in any feasible combination. The operations may further include: upon determining that the second value of the second entity is absent from the natural language command, generating a second request for the second value; and in response to receiving the second value, generating the first request for the enterprise software application to execute the workflow.

In some variations, the parsing of the natural language command is performed by applying a rule-based natural language processing technique.

In some variations, the parsing of the natural language command may be performed by applying a machine learning model.

In some variations, the operations may further include: generating, based at least on the knowledge graph, training data for training the machine learning model.

In some variations, the generating of the training data may include traversing the knowledge graph to identify the first entity and the second entity related to the first entity, and slot filling a query template by at least inserting a first value into a first slot corresponding to the first entity and a second value into a second slot corresponding to the second entity.

In some variations, the machine learning model may include a linear model, a decision tree, an ensemble method, a support vector machine, a Bayesian model, a deep neural network, a deep belief network, a recurrent neural network, and/or a convolutional neural network.

In some variations, the ontology may define a relationship between the first entity and the second entity. The knowledge graph may represent the relationship between the first entity and the second entity by at least including a first node corresponding to the first entity being connected by a directed edge to a second node corresponding to the second entity.

In some variations, the first entity may correspond to the enterprise workflow. The second entity may correspond to a first operation that is performed in order to execute the enterprise workflow.

In some variations, the knowledge graph may further include a third node corresponding to a third entity related to the first entity and/or the second entity. The third entity may include a second operation that is performed in order to execute the enterprise workflow.

In another aspect, there is provided a method for natural language processing augmented with knowledge graph. The method may include: in response to receiving a natural language command invoking a workflow of an enterprise software application, parsing the natural language command to identify at a first entity associated with a first value included in the natural language command; determining, based at least on a knowledge graph representative of an ontology associated with the enterprise software application, a second entity related to the first entity; and generating a first request for the enterprise software application execute the workflow based at least on the first value of the first entity and a second value of the second entity.

In some variations, one or more of the features disclosed herein including the following features can optionally be included in any feasible combination. The method may further include: upon determining that the second value of the second entity is absent from the natural language command, generating a second request for the second value; and in response to receiving the second value, generating the first request for the enterprise software application to execute the workflow.

In some variations, the parsing of the natural language command is performed by applying a rule-based natural language processing technique.

In some variations, the parsing of the natural language command may be performed by applying a machine learning model.

In some variations, the method may further include: generating, based at least on the knowledge graph, training data for training the machine learning model.

In some variations, the generating of the training data may include traversing the knowledge graph to identify the first entity and the second entity related to the first entity, and slot filling a query template by at least inserting a first value into a first slot corresponding to the first entity and a second value into a second slot corresponding to the second entity.

In some variations, the machine learning model may include a linear model, a decision tree, an ensemble method, a support vector machine, a Bayesian model, a deep neural network, a deep belief network, a recurrent neural network, and/or a convolutional neural network.

In some variations, the ontology may define a relationship between the first entity and the second entity. The knowledge graph may represent the relationship between the first entity and the second entity by at least including a first node corresponding to the first entity being connected by a directed edge to a second node corresponding to the second entity. The first entity may correspond to the enterprise workflow. The second entity may correspond to a first operation that is performed in order to execute the enterprise workflow.

In some variations, the knowledge graph may further include a third node corresponding to a third entity related to the first entity and/or the second entity. The third entity may include a second operation that is performed in order to execute the enterprise workflow.

In another aspect, there is provided a computer program product that includes a non-transitory computer readable storage medium. The non-transitory computer-readable storage medium may include program code that causes operations when executed by at least one data processor. The operations may include: in response to receiving a natural language command invoking a workflow of an enterprise software application, parsing the natural language command to identify at a first entity associated with a first value included in the natural language command; determining, based at least on a knowledge graph representative of an ontology associated with the enterprise software application, a second entity related to the first entity; and generating a first request for the enterprise software application execute the workflow based at least on the first value of the first entity and a second value of the second entity.

Implementations of the current subject matter can include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to natural language processing, it should be readily understood that such features are not intended to be limiting. The claims that follow this disclosure are intended to define the scope of the protected subject matter.

### DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1A depicts a system diagram illustrating a natural language processing system, in accordance with some example embodiments;

FIG. 1B depicts a block diagram illustrating an example architecture of a natural language processing system, in accordance with some example embodiments;

FIG. 2A depicts a schematic diagram illustrating an example of a semantic layer underlying a knowledge graph, in accordance with some example embodiments;

FIG. 2B depicts an example of a knowledge graph, in accordance with some example embodiments;

FIG. 3 depicts a sequence diagram illustrating an example of a process for training a machine learning model to perform a natural language processing task, in accordance with some example embodiments;

FIG. 4A depicts a sequence diagram illustrating an example of a process for knowledge graph based natural language processing, in accordance with some example embodiments;

FIG. 4B depicts a sequence diagram illustrating another example of a process for knowledge graph based natural language processing, in accordance with some example embodiments;

FIG. 5 depicts a flowchart illustrating an example of a process for knowledge graph based natural language processing, in accordance with some example embodiments; and

FIG. 6 depicts a block diagram illustrating an example of a computing system, in accordance with some example embodiments.

When practical, like labels are used to refer to same or similar items in the drawings.

### DETAILED DESCRIPTION

Enterprise software applications may support a variety of enterprise workflows including, for example, billing, invoicing, procurement, payroll, time and attendance management, recruiting and onboarding, learning and development, performance and compensation, workforce planning, and/or the like. In some cases, user interactions with an enterprise software application may be conducted via a conversation simulation application (e.g., a chatbot and/or the like). Accordingly, one or more data processing functionalities of the enterprise software application may be invoked using natural language commands. In some cases, instead of being a text input, the natural language commands may be received as a voice command received via a voice based user interface.

The conversation simulation application may receive a natural language command invoking an enterprise workflow associated with an enterprise software application, such as assigning a source of supply within an enterprise resource planning (ERP) application, that requires performing a sequence of operations. In some cases, at least some of the data values required to perform the sequence of the operations may be absent from the natural language command. Moreover, at least some of those operations, such as the selection of a supplier, may require the performance of additional actions. As such, upon receiving a natural language command, the conversation simulation application may parse the natural language command to identify the enterprise workflow invoked by the natural language command and extract, from the natural language command, at least a portion of the data values required for perform the corresponding sequence of operations. In the event some of the data values required to perform the sequence of operations are absent from the natural language command, the conversation simulation application may generate a natural language response to include a request for the absent data values.

In order to parse a variety of natural language commands, the conversation simulation application may be required to recognize the relationships that exist between various enterprise workflows, the sequence of operations associated with each enterprise workflow, the data objects that are affected by each operation, and the data values required to perform individual operations. For example, the conversation simulation application may apply a variety of natural language processing (NLP) techniques, such as rule-based models, traditional machine learning models, and deep learning models, to parse each incoming natural language command and identify the entities included therein. However, the complexity of the aforementioned relationships makes it difficult to integrate such knowledge during the development of the conversation simulation application. One conventional solution is to hardcode each enterprise workflow and the corresponding operations and data values into the logic of the conversation simulation application. However, with this brute force approach, the resulting conversation simulation application may be incapable of adapting to even slight changes in an enterprise workflow.

In some example embodiments, a conversation simulation application (e.g., a chatbot and/or the like) may leverage a knowledge graph to parse and analyze incoming natural language commands. The knowledge graph may enumerate the relationships that exist between various enterprise workflows, the sequence of operations associated with each enterprise workflow, the data objects that are affected by each operation, and the data values required to perform individual operations. That is, the knowledge graph may provide a graphical representation of the underlying ontology of the various enterprise workflows supported by the enterprise software applications. This graphical representation may combine the semantic role of the ontology with actual data points such as, for instance, a semantic description of an hypertext transfer protocol (HTTP) request as well as the actual data. For example, the knowledge graph may represent the aforementioned relationships as a network of interconnected nodes, with each node being an entity and the edges representative of a relationship between the entities of the adjoined nodes. As such, a first node representative of an enterprise workflow may be connected by a directed edge to a second node representative of an operation, which in turn is connected by a directed edge to a third node representative of a data object. The graphical relationship between the first node, the second node, and the third node may indicate that executing the enterprise workflow of the first node requires performing the operation of the second node on the data object of the third node. Moreover, the attributes associated with the first node may correspond to the data values required to execute the enterprise workflow of the first node. These data values may determine the selection of the operation corresponding to the second node and may be a part of the input of that operation. Meanwhile, the attributes associated with the second node may correspond to the any additional data values required to perform the operation of the second node, for example, on the data object of the third node.

Accordingly, upon receiving a natural language command invoking an enterprise workflow of an enterprise software application, the conversation simulation application may parse the natural language command to identify at least a first entity specified by the natural language command. Moreover, the conversation simulation application may traverse the knowledge graph in order to identify a first attribute of the first entity, a second entity related to the first entity, and/or a second attribute of the second entity. In the event the natural language command does not include the first attribute and/or the second attribute, the conversation simulation application may generate a natural language response that includes a request for the first attribute and/or the second attribute. Upon receiving the first attribute and the second attribute, whether in the natural language command or in subsequent responses, the conversation simulation application may generate a request (e.g., an application programming interface (API) call and/or the like), which may be sent to the enterprise software application to execute the enterprise workflow invoked by the natural language command.

In some example embodiments, the knowledge graph may be further leveraged to generate training samples for a machine learning model used by the conversation simulation application to parse incoming natural language commands. For example, a training sample may be generated by at least traversing the knowledge graph to fill one or more slots in a template for a natural language command. Each slot in the template may correspond to an entity or an attribute associated with an entity. Accordingly, by traversing the knowledge graph, the slots in the template may be filled with values that are consistent with the relationships between various enterprise workflows, the sequence of operations associated with each enterprise workflow, the data objects that are affected by each operation, and the data values required to perform individual operations.

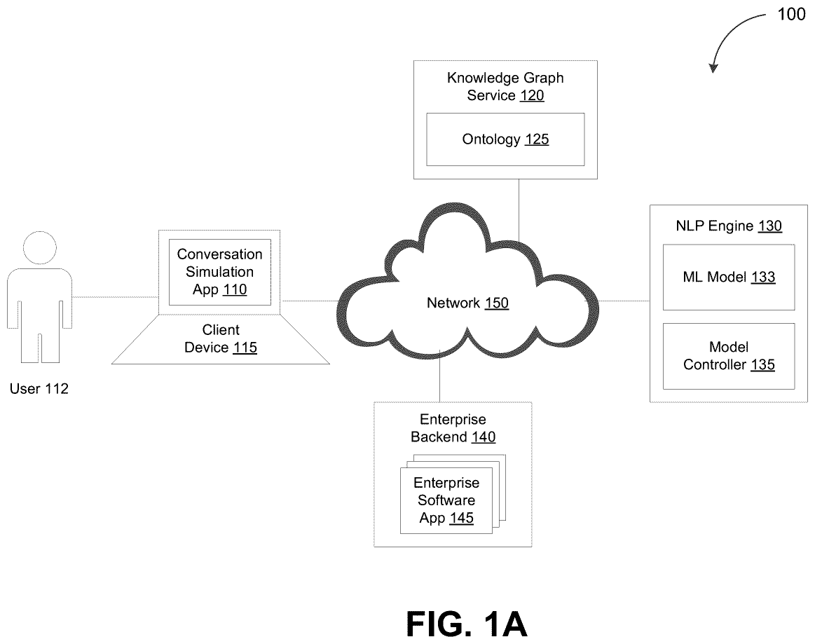

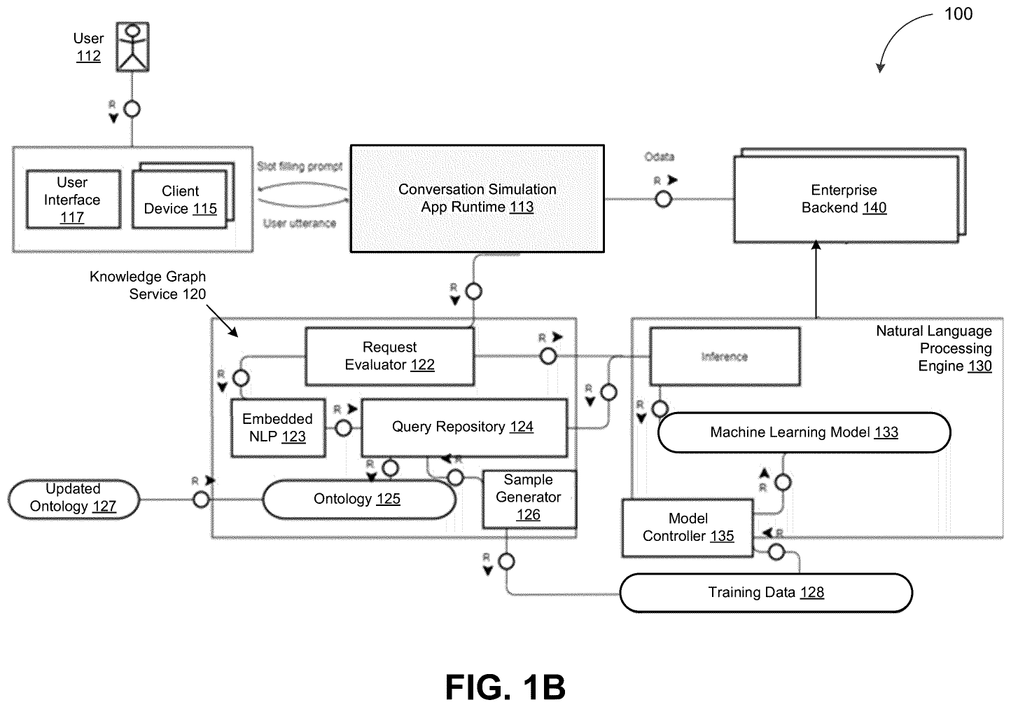

FIG. 1A depicts a system diagram illustrating a natural language processing system 100, in accordance with some example embodiments. Referring to FIG. 1A, the natural language processing system 100 may include a simulated conversation application 110 deployed at a client device 115, a knowledge graph service 120, a natural language processing (NLP) engine 130 with a machine learning model 133 and a model controller 135, and an enterprise backend 140 hosting one or more enterprise software applications 145. As shown in FIG. 1, the client device 115, the knowledge graph service 120, the natural language processing engine 130, and the enterprise backend 140 may be communicatively coupled via a network 140. The client device 115 may be a processor-based device including, for example, a smartphone, a tablet computer, a wearable apparatus, a virtual assistant, an Internet-of-Things (IoT) appliance, and/or the like. The network 150 may be a wired network and/or a wireless network including, for example, a wide area network (WAN), a local area network (LAN), a virtual local area network (VLAN), a public land mobile network (PLMN), the Internet, and/or the like.

In some example embodiments, the conversation simulation application 110 (e.g., a chatbot and/or the like) may leverage a knowledge graph to parse and analyze a natural language command received, for example, from a user 112 at the client device 115. For example, as shown in FIG. 1A, the knowledge graph service 120 may maintain an ontology 125 associated with the various enterprise workflows supported by the one or more enterprise software applications 145. The ontology 125 may be configured in a Web Ontology Language (WOL) to define the relationships that exist between various enterprise workflows, the sequence of operations associated with each enterprise workflow, the data objects that are affected by each operation, and the data values required to perform individual operations. Meanwhile, the corresponding knowledge graph may provide a graphical representation of these relationships as, for example, a collection of interconnected nodes. It should be appreciated that the ontology 125 may be adapted to reflect changes in the enterprise workflows associated with the one or more enterprise software applications 145. For instance, FIG. 1B shows that an updated ontology 127 with changes to one or more enterprise workflows may replace the ontology 125 such that subsequent natural language commands may be parsed based on the updated ontology 127.

In some example embodiments, upon receiving the natural language command, the conversation simulation application 110 may query the knowledge graph service 120 in order to parse, based at least on the ontology 125, the natural language command. To further illustrate, FIG. 1B depicts a block diagram illustrating an example architecture of the natural language processing system 100, in accordance with some example embodiments. Referring to FIG. 1B, the user 112 at the client device 115 may interact with a user interface 117 associated with the conversation simulation application 110 to provide one or more user inputs corresponding to a natural language command. For example, the one or more user inputs may include voice inputs received via a microphone at the client device 115 and/or text inputs provided via a keyboard, a mouse, and/or a touchscreen at the client device 115. Moreover, the natural language command may invoke one or more enterprise workflows supported by the one or more enterprise software application 145 hosted at the enterprise backend 140.

In the example shown in FIG. 1B, the runtime 113 of the conversation simulation application 110 may receive the natural language command before passing the natural language command to a request evaluator 122 at the knowledge graph service 120. In some cases, the knowledge graph service 120 may resolve the natural language command using an embedded natural language processor 123, which may parse the natural language command using one or more non-machine learning based techniques (e.g., rule-based models and/or the like). Alternatively, the knowledge graph service 120 may send the natural language command to the natural language processing engine 130, which may be configured to resolve the natural language command by applying the machine learning model 133. It should be appreciated that the machine learning model 133 may be a traditional machine learning model, which may be a non-deep learning model such as, for example, a linear model, a decision tree, an ensemble method, a support vector machine, a Bayesian model, and/or the like. Alternatively and/or additionally, the machine learning model 133 may be a deep learning model such as a deep neural network, a deep belief network, a recurrent neural network, a convolutional neural network, and/or the like.

In some example embodiments, the parsing of the natural language command may include identifying at least a first entity specified by the natural language command and identifying, based at least on the ontology 125, a first attribute of the first entity, a second entity related to the first entity, and/or a second attribute of the second entity. For example, the request evaluator 122 may traverse a knowledge graph associated with the ontology 125 to identify the first attribute of the first entity, the second entity related to the first entity, and/or the second attribute of the second entity. In some cases, the request evaluator 122 may determine that the first attribute and/or the second attribute is absent from the natural language command. When that is the case, the runtime 113 of the conversation simulation application 110 may generate, for output at the client device 115, a natural language response that includes a request for the first attribute and/or the second attribute. Upon receiving the first attribute and the second attribute, whether in the natural language command or in subsequent responses from the user 112 at the client device 115, the runtime 113 of the conversation simulation application 110 may generate a request (e.g., an application programming interface (API) call and/or the like), which may be sent to the enterprise backend 140 hosting the one or more enterprise software application 145 to execute the enterprise workflow invoked by the natural language command.

Referring again to FIG. 1B, in some example embodiments, the knowledge graph service 120 may include a sample generator 126 configured to generate training data 128, which may be used by the model controller 135 to train the machine learning model 133 to parse natural language commands. As shown in FIG. 1B, the sample generator 126 may generate a training sample by at least filling, based at least on the ontology 125, one or more slots in a query template for a natural language command (e.g., from a query repository 124). Each slot in the query template may correspond to an entity or an attribute associated with an entity. Accordingly, by traversing the knowledge graph associated with the ontology 125, the slots in the template may be filled with values that are consistent with the relationships between various enterprise workflows, the sequence of operations associated with each enterprise workflow, the data objects that are affected by each operation, and the data values required to perform individual operations.

To further illustrate, Table 1 below depicts an example of a query template having slots for multiple entities including a first attribute (e.g., ATTRIBUTE_1) and a second attribute (ATTRIBUTE_DATETIME_2) of a data object (e.g., DATA_OBJECT_1). To generate a corresponding training sample, the sample generator 126 may insert a first value into a first slot corresponding to the first attribute and a second value into a second slot corresponding to the second attribute. In the example of the query template shown in Table 1, the second attribute may be associated with a specific datatype (e.g., DATETIME). Accordingly, the sample generator 126 may provide values having the specific datatype when slot filling the corresponding values (e.g., VALUE_1 and VALUE_2).

Table 1

“I want to know #ATTRIBUTE_1 of #DATA_OBJECT_1 having #ATTRIBUTE_DATETIME_2 between #VALUE_1 to #VALUE_2”

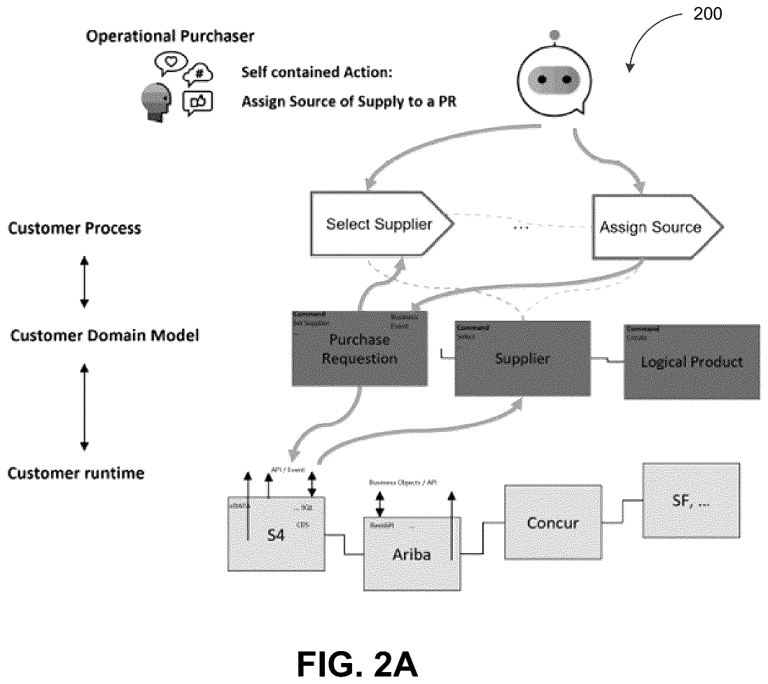

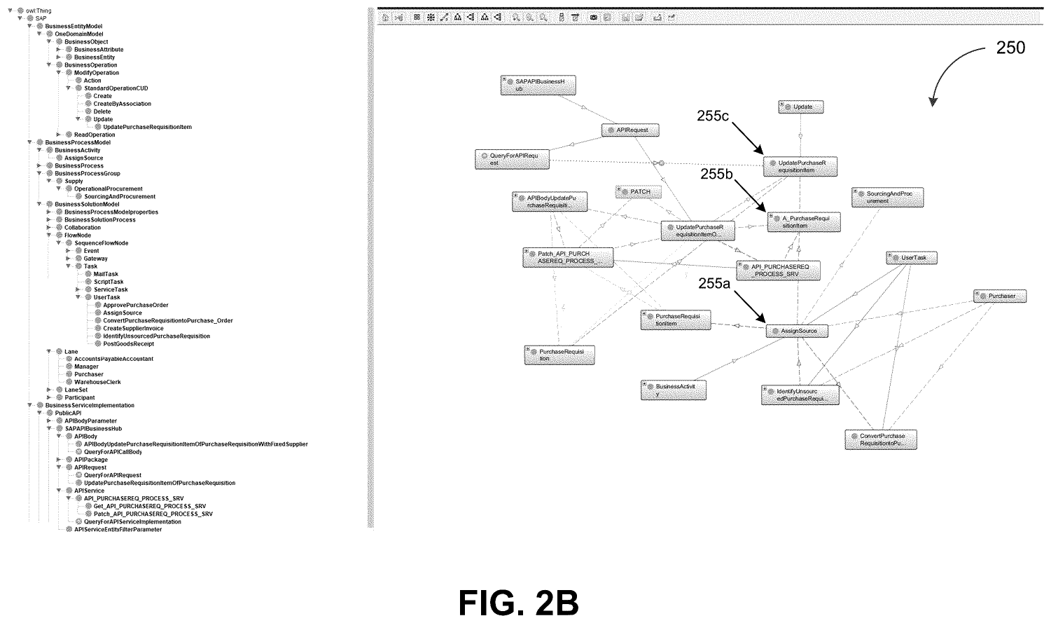

As noted, the ontology 125 may be associated with a knowledge graph that provides a graphical representation of the relationships defined by the ontology 125. FIG. 2A depicts a schematic diagram illustrating an example of a semantic layer 200 underlying a knowledge graph, in accordance with some example embodiments. As shown in FIG. 2A, the enterprise workflows supported by the one or more enterprise software applications 145 may be associated with various relationships, for example, between individual enterprise workflows, the sequence of operations associated with each enterprise workflow, the data objects that are affected by each operation, and the data values required to perform individual operations. Collectively, these relationships may be defined by the ontology 125, which may be updated (e.g., the updated ontology 127) to reflect any changes therein.

FIG. 2B depicts an example of a knowledge graph 250 corresponding, for example, to the ontology 125. As shown in FIG. 2B, the knowledge graph 250 may represent the relationships defined by the ontology 125 as a network of interconnected nodes, with each node being an entity and the edges representative of a relationship between the entities of the adjoined nodes. For example, the request evaluator 122 may traverse the knowledge graph 250 to parse the natural language command “Assign source of supply SoS_2 to purchase requisition PR_A.” The request evaluator 122 traversing the knowledge graph 250 may identify a first node 255a representative of the enterprise workflow “AssignSource.” As shown in FIG. 2B, the first node 255a corresponding to the enterprise workflow “AssignSource” may be connected by a directed edge to a second node 255b representative of the data object “PurchaseRequisitionItem,” which may in turn be connected by a directed edge to a third node 255c representative of the operation “UpdatePurchaseRequisitionItem.”

The graphical relationship between the first node 255a, the second node 255b, and the third node 255c may indicate that executing the enterprise workflow of the first node 255a requires performing the operation of the third node 255c on the data object of the second node 255d. Moreover, the attributes associated with the first node 255a may correspond to the data values required to execute the enterprise workflow of the first node 255a. In some cases, these data values may determine the selection of the operation corresponding to the third node 255c and may be a part of the input of that operation. Meanwhile, the attributes associated with the third node 255c may correspond to the any additional data values required to perform the operation of the third node 255c, for example, on the data object of the second node 255b.

The request evaluator 122 may determine, by at least traversing the knowledge graph 250, whether the natural language command includes the data values required to perform the enterprise workflow “AssignSource” including the constituent operation “UpdatePurchaseRequisitionItem.” In the event some data values are absent from the natural language command, the runtime 113 of the conversation simulation application 110 may generate, for output at the client device 115, a natural language response that includes a request for the missing data values. Upon receiving the data values required to perform the enterprise workflow “AssignSource,” whether in the natural language command or in subsequent responses from the user 112 at the client device 115, the runtime 113 of the conversation simulation application 110 may generate a request (e.g., an application programming interface (API) call and/or the like), which may be sent to the enterprise backend 140 hosting the one or more enterprise software application 145 to execute the enterprise workflow “AssignSource.”

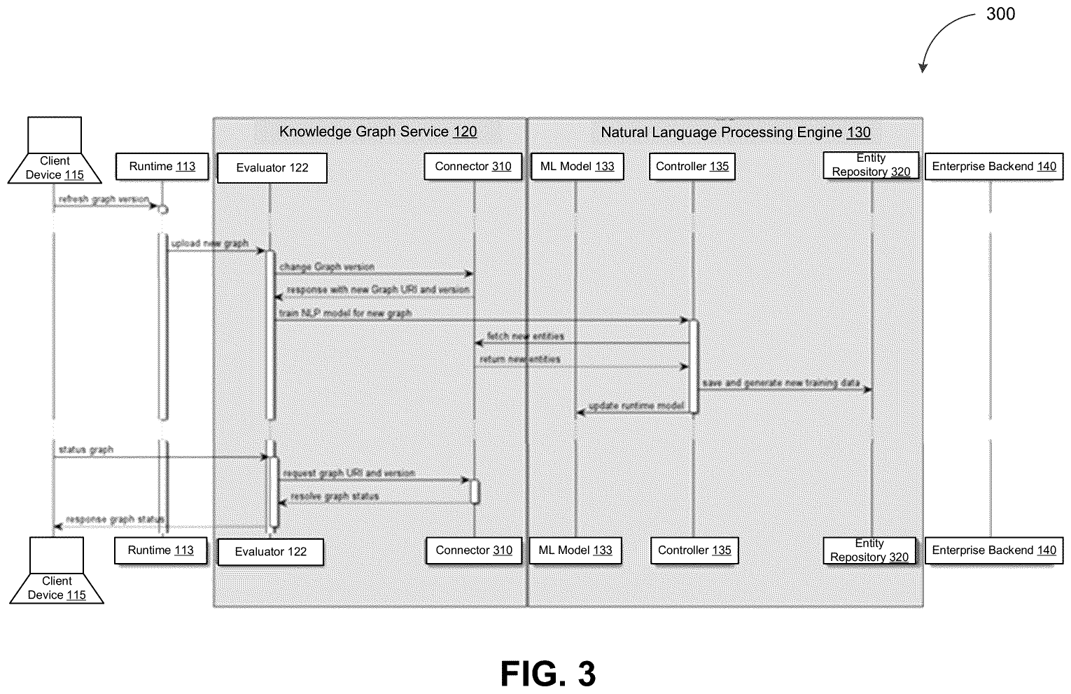

FIG. 3 depicts a sequence diagram illustrating an example of a process 300 for training the machine learning model 133 to parse natural language commands by at least performing one or more natural language processing (NLP) tasks. For example, the machine learning model 133 may be trained to identify entities present within a natural language command received at the conversation simulation application 110. The task of entity detection may include linking attributes to the data values included in a natural language command, thus inferring the corresponding entities and mapping these entities to those included in the knowledge graph. As such, the knowledge graph service 120 may traverse, for example, the knowledge graph 250 to identify other entities related to those present within the natural language command. In the event the natural language command does not provide every data value required to perform the enterprise workflow invoked by the natural language command.

Referring to FIG. 3, the runtime 113 of the conversation simulation application 110 may receive, from the client device 115, one or more user inputs that trigger an update to the knowledge graph 250. This may occur when the one or more user inputs specify a change to the ontology 125 represented by the knowledge graph 250 such as, for example, adding, removing, and/or updating an enterprise workflow. As shown in FIG. 3, the runtime 113 of the conversation simulation application 110 may send, to the request evaluator 122, a corresponding request to upload a new version of the knowledge graph 250. In response to the request from the runtime 113 of the conversation simulation application 110, the request evaluator 122 may send, to a graph connector 310, a corresponding request to change the current version of the knowledge graph 250. The graph connector 310 may respond to this request by providing a reference, such as a universal resource identifier (URI), for the updated version of the knowledge graph 250.

In some example embodiments, the request evaluator 122 may send, to the model controller 135, a request to train the machine learning model 133 in accordance with the updated version of the knowledge graph 250. For example, the model controller 135 may generate one or more training samples by at least slot filling one or more query templates from the query repository 124 with entities fetched from the updated version of the knowledge graph 250 by calling the graph connector 310. As shown in FIG. 3, the model controller 135 may save the entities fetched from the knowledge graph 250 in an entity repository 320. Moreover, the model controller 135 may update the machine learning model 133 by at least training the machine learning model 133 using the training samples generated based on the updated version of the knowledge graph 250.

As shown in FIG. 3, the graph connector 310 may also be called in order to resolve requests for the current status of the knowledge graph 250. For example, as shown in FIG. 3, the request evaluator 122 may receive, from the client device 115, a request for the current status of the knowledge graph 250. As used herein, the status of the knowledge graph 250 may include information associated with the knowledge graph 250 that enables an identification of the deployed knowledge graph 250 including, for example, an identifier of the knowledge graph 250 (e.g., a uniform resource identifier (URI)), a version, and/or the like. The request evaluator 122 may call the graph connector 310 in response to the request for the current status of the knowledge graph 250. For instance, as shown in FIG. 3, the request evaluator 122 may call the graph connector 310 in order to obtain a reference (e.g., a universal resource identifier (URI) and/or the like) and a version identifier for the current version of the knowledge graph 250. Moreover, the request evaluator 122 may resolve the status of the knowledge graph 250 based on the response received from the graph connector 310 before providing, to the client device 115, the status of the knowledge graph 250.

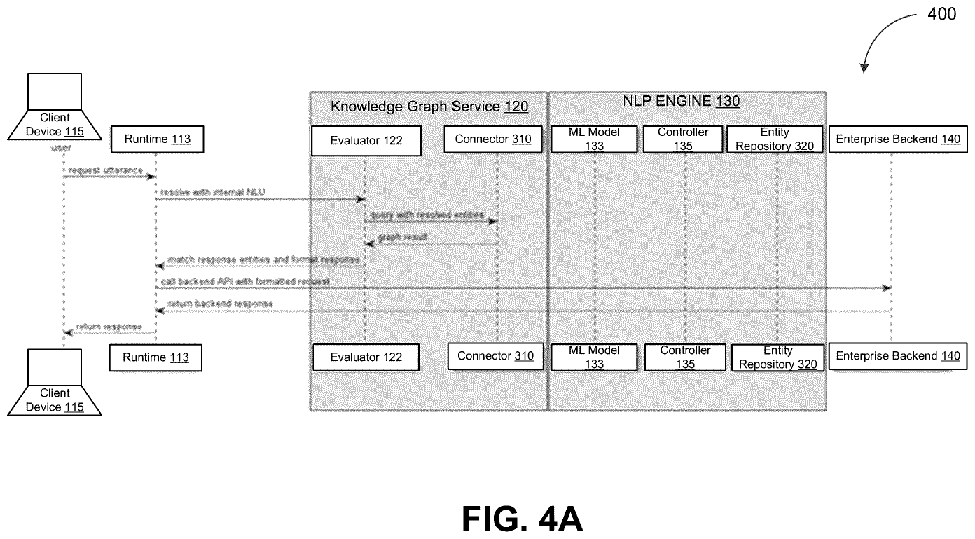

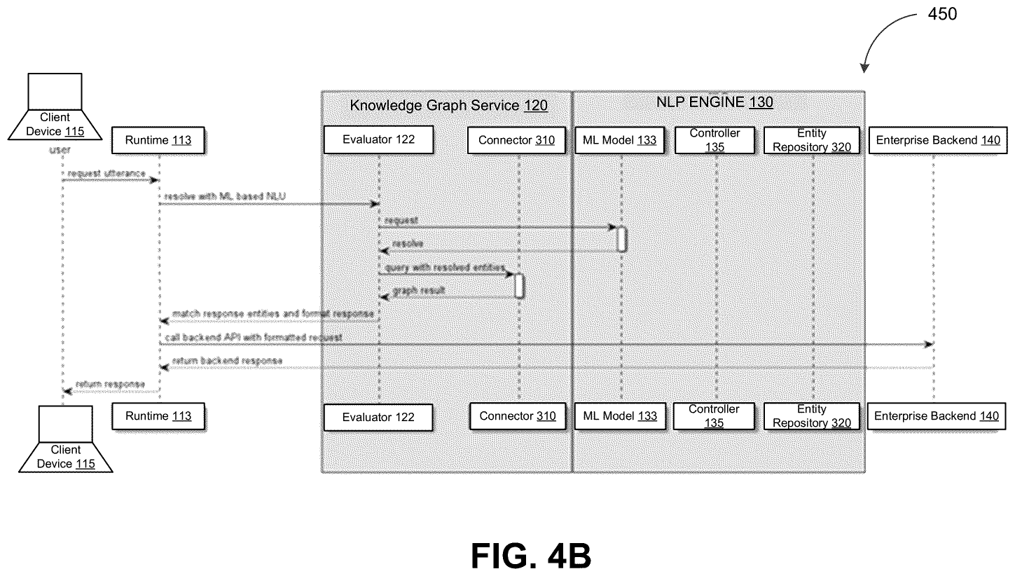

FIG. 4A depicts a sequence diagram illustrating an example of a process 400 for knowledge graph based natural language processing, in accordance with some example embodiments. Referring to FIGS. 1B and 4A, in some cases, the conversation simulation application 110 may resolve natural language commands received from the client device 115 using the embedded natural language processor (NLP) 123, which applies one or more non-machine learning based techniques (e.g., rule-based models and/or the like) to parse the natural language commands, instead of the machine learning based natural language processing engine 130.

Referring again to FIG. 4A, the runtime 113 of the conversation simulation application 110 may receive, from the client device 115, a natural language command input by the user 112 at the client device 115. In the example shown in FIG. 4A, the natural language command may be resolved using the embedded natural language processor (NLP) 123, which applies one or more non-machine learning based techniques (e.g., rule-based models and/or the like) to parse the natural language command and identify one or more entities included in the natural language command. For example, the embedded natural language processor 123 may map the values included in the natural language command to the one or more entities before these entities are sent to the knowledge graph service 120 where the request evaluator 122 may identify, based at least on the knowledge graph 250, one or more related entities. For instance, if the natural language command includes a first entity corresponding to an enterprise workflow invoked by the natural language command, the graph connector 310 may traverse the knowledge graph 250 to identify a second entity corresponding to an operation included in the enterprise workflow.

In some cases, upon identifying the second entity related to the first entity included in the natural language command, the runtime 113 of the conversation simulation application 110 may determine that one or more values required to perform the corresponding operation are absent from the natural language command. As such, the runtime 113 of the conversation simulation application 110 may send, to the client device 115, a response including a request for the absent values. Upon receiving the values required to perform the enterprise workflow, the runtime 113 of the conversation simulation application 110 may generate a formatted request for calling an application programming interface (API) of the enterprise backend 140 to execute the enterprise workflow. As shown in FIG. 4A, the runtime 113 of the conversation simulation application 110 may provide, to the client device 115, the result of executing the enterprise workflow.

FIG. 4B depicts a sequence diagram illustrating another example of a process 450 for knowledge graph based natural language processing, in accordance with some example embodiments. Referring to FIGS. 1B and 4B, in some cases, the conversation simulation application 110 may be configured to resolve natural language commands received from the client device 115 using the natural language processing engine 130, which may apply the machine learning model 133 in order to parse each natural language command and infer the entities specified therein. The machine learning model 133 may be trained based on the training data 128, which may include training samples generated based at least on the ontology 125 defining the knowledge graph 250. Accordingly, the natural language processing engine 130 may be capable of parsing natural language commands with higher accuracy than the embedded natural language processor (NLP) 123.

As shown in FIG. 4B, the runtime 113 of the conversation simulation application 110 may receive, from the client device 115, a natural language command input by the user 112 at the client device 115. In the example shown in FIG. 4B, the natural language command may be resolved by applying the machine learning model 133. For example, the natural language command may invoke an enterprise workflow by at least specifying one or more corresponding values. Accordingly, the machine learning model 133 may map the values included in the natural language command to the one or more entities before these entities are sent to the knowledge graph service 120 where the request evaluator 122 may identify one or more related entities by at least traversing the knowledge graph 250. In cases where one or more of the values required to perform the enterprise workflow are absent from the natural language command, the runtime 113 of the conversation simulation application 110 may send, to the client device, one or more responses with requests for these values.

Upon receiving the values required to perform the enterprise workflow, whether in the initial natural language command or in responses to subsequent requests, the runtime 113 of the conversation simulation application 110 may generate a formatted request for calling an application programming interface (API) of the enterprise backend 140 to execute the enterprise workflow. As shown in FIG. 4B, the runtime 113 of the conversation simulation application 110 may provide, to the client device 115, the result of executing the enterprise workflow.

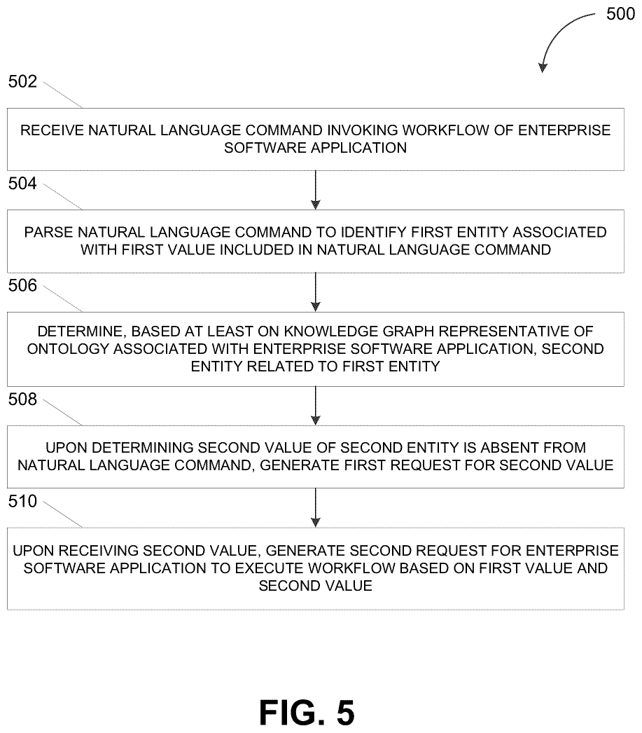

FIG. 5 depicts a flowchart illustrating an example of a process 500 for knowledge graph based natural language processing, in accordance with some example embodiments. Referring to FIGS. 1-5, the process 500 may be performed by the conversation simulation application 110, for example, by the runtime 113 of the conversation simulation application 110.

At 502, the conversation simulation application 110 may receive a natural language command invoking a workflow of an enterprise software application. For example, the runtime 113 of the conversation simulation application 110 may receive, from the client device 115, a natural language command input by the user 112 at the client device 115. The natural language command may be provided as a text input and/or a voice input. Moreover, the natural language command may invoke an enterprise workflow associated with the one or more enterprise software applications 145 hosted at the enterprise backend 140.

At 504, the conversation simulation application 110 may parse the natural language command to identify a first entity associated with a first value included in the natural language command. In some example embodiments, the conversation simulation application 110 may resolve the natural language command received from the client device 115 using the embedded natural language processor (NLP) 123, which applies one or more non-machine learning based techniques (e.g., rule-based models and/or the like) to parse the natural language command. Alternatively, the conversation simulation application 110 may resolve the natural language command by calling the natural language processing (NLP) engine 130 to apply the machine learning model 133. As noted, the machine learning model 133 may be implemented using a traditional machine learning model or a deep learning model. The parsing of the natural language command may include inferring, based at least on a first value included in the natural language command, a first entity corresponding to the first value. For example, the natural language command “Assign source of supply SoS_2 to purchase requisition PR_A” may include the value “assign source of supply SoS_2,” which may correspond to the enterprise workflow “AssignSource.”

At 506, the conversation simulation application 110 may determine, based at least on a knowledge graph representative of an ontology associated with the enterprise software application, a second entity related to the first entity. For example, the knowledge graph 250 may provide a graphical representation of the ontology 125, which defines the relationships that exist between various enterprise workflows, the sequence of operations associated with each enterprise workflow, the data objects that are affected by each operation, and the data values required to perform individual operations. Accordingly, upon determining that the value “assign source of supply SoS_2” in the natural language command corresponds to the enterprise workflow “AssignSource,” the conversation simulation application 110 may call the knowledge graph service 120 to identify, based at least on the knowledge graph 250, additional entities related to the enterprise workflow “AssignSource,” such as the data object “PurchaseRequisitionItem” and the operation “UpdatePurchaseRequisitionItem.”

At 508, upon determining that a second value of the second entity is absent from the natural language command, the conversation simulation application 110 may generate a first request for the second value. In cases where the initial natural language command fails to provide every value required to execute the enterprise workflow invoked by the natural language command, the runtime 113 of the conversation simulation application 110 may generate requests for these values. For example, where the natural language command fails to include the value “PR_A” for the data object “PurchaseRequisitionItem,” the runtime 113 of the conversation simulation application 110 may send, to the client device 115, a request for the value.

At 510, in response to receiving the second value, the conversation simulation application 110 may generate a second request for the enterprise software application to execute the workflow based on the first value and the second value. For example, as shown in FIGS. 4A-B, the runtime 113 of the conversation simulation application 110 may generate a formatted request for calling an application programming interface (API) of the enterprise backend 140 to execute the enterprise workflow “AssignSource”. Furthermore, as shown in FIGS. 4A-B, the runtime 113 of the conversation simulation application 110 may provide, to the client device 115, the result of executing the enterprise workflow “AssignSource.”

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A system, comprising: at least one data processor; and at least one memory storing instructions, which when executed by the at least one data processor, result in operations comprising: in response to receiving a natural language command invoking a workflow of an enterprise software application, parsing the natural language command to identify at a first entity associated with a first value included in the natural language command; determining, based at least on a knowledge graph representative of an ontology associated with the enterprise software application, a second entity related to the first entity; and generating a first request for the enterprise software application execute the workflow based at least on the first value of the first entity and a second value of the second entity.

Example 2: The system of Example 1, wherein the operations further comprise: upon determining that the second value of the second entity is absent from the natural language command, generating a second request for the second value; and in response to receiving the second value, generating the first request for the enterprise software application to execute the workflow.

Example 3: The system of any one of Examples 1 to 2, wherein the parsing of the natural language command is performed by applying a rule-based natural language processing technique.

Example 4: The system of any one of Examples 1 to 3, wherein the parsing of the natural language command is performed by applying a machine learning model.

Example 5: The system of Example 4, wherein the operations further comprise: generating, based at least on the knowledge graph, training data for training the machine learning model.

Example 6: The system of Example 5, wherein the generating of the training data includes traversing the knowledge graph to identify the first entity and the second entity related to the first entity, and slot filling a query template by at least inserting a first value into a first slot corresponding to the first entity and a second value into a second slot corresponding to the second entity.

Example 7: The system of any one of Examples 4 to 6, wherein the machine learning model comprises a linear model, a decision tree, an ensemble method, a support vector machine, a Bayesian model, a deep neural network, a deep belief network, a recurrent neural network, and/or a convolutional neural network.

Example 8: The system of any one of Examples 1 to 7, wherein the ontology defines a relationship between the first entity and the second entity, and wherein the knowledge graph represents the relationship between the first entity and the second entity by at least including a first node corresponding to the first entity being connected by a directed edge to a second node corresponding to the second entity.

Example 9: The system of Example 8, wherein the first entity corresponds to the enterprise workflow, and wherein the second entity corresponds to a first operation that is performed in order to execute the enterprise workflow.

Example 10: The system of Example 9, wherein the knowledge graph further includes a third node corresponding to a third entity related to the first entity and/or the second entity, and wherein the third entity comprises a second operation that is performed in order to execute the enterprise workflow.

Example 11: A computer-implemented method, comprising: in response to receiving a natural language command invoking a workflow of an enterprise software application, parsing the natural language command to identify at a first entity associated with a first value included in the natural language command; determining, based at least on a knowledge graph representative of an ontology associated with the enterprise software application, a second entity related to the first entity; and generating a first request for the enterprise software application execute the workflow based at least on the first value of the first entity and a second value of the second entity.

Example 12: The method of Example 11, further comprising: upon determining that the second value of the second entity is absent from the natural language command, generating a second request for the second value; and in response to receiving the second value, generating the first request for the enterprise software application to execute the workflow.

Example 13: The method of any one of Examples 11 to 12, wherein the parsing of the natural language command is performed by applying a rule-based natural language processing technique.

Example 14: The method of any one of Examples 11 to 13, wherein the parsing of the natural language command is performed by applying a machine learning model.

Example 15: The method of Example 14, further comprising: generating, based at least on the knowledge graph, training data for training the machine learning model.

Example 16: The method of Example 15, wherein the generating of the training data includes traversing the knowledge graph to identify the first entity and the second entity related to the first entity, and slot filling a query template by at least inserting a first value into a first slot corresponding to the first entity and a second value into a second slot corresponding to the second entity.

Example 17: The method of any one of Examples 14 to 16, wherein the machine learning model comprises a linear model, a decision tree, an ensemble method, a support vector machine, a Bayesian model, a deep neural network, a deep belief network, a recurrent neural network, and/or a convolutional neural network.

Example 18: The method of any one of Examples 11 to 17, wherein the ontology defines a relationship between the first entity and the second entity, wherein the knowledge graph represents the relationship between the first entity and the second entity by at least including a first node corresponding to the first entity being connected by a directed edge to a second node corresponding to the second entity, wherein the first entity corresponds to the enterprise workflow, and wherein the second entity corresponds to a first operation that is performed in order to execute the enterprise workflow.

Example 19: The method of Example 18, wherein the knowledge graph further includes a third node corresponding to a third entity related to the first entity and/or the second entity, and wherein the third entity comprises a second operation that is performed in order to execute the enterprise workflow.

Example 20: A non-transitory computer readable medium storing instructions, which when executed by at least one data processor, result in operations comprising: in response to receiving a natural language command invoking a workflow of an enterprise software application, parsing the natural language command to identify at a first entity associated with a first value included in the natural language command; determining, based at least on a knowledge graph representative of an ontology associated with the enterprise software application, a second entity related to the first entity; and generating a first request for the enterprise software application execute the workflow based at least on the first value of the first entity and a second value of the second entity.

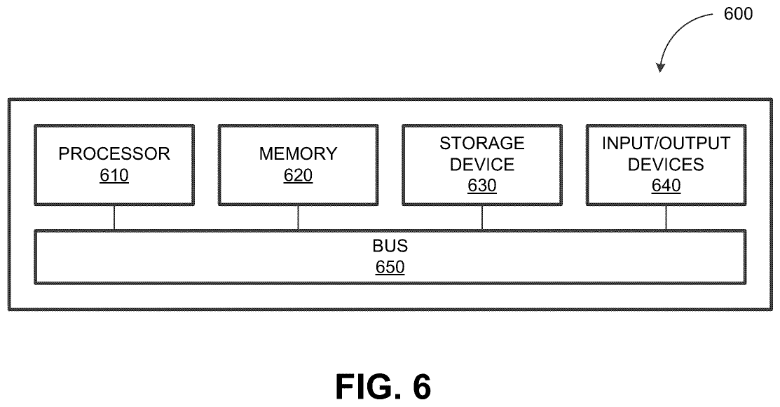

FIG. 6 depicts a block diagram illustrating a computing system 600, in accordance with some example embodiments. Referring to FIGS. 1-6, the computing system 600 can be used to implement the client device 115, the knowledge graph service 120, the natural language processing engine 130, the enterprise backend 140, and/or any components therein.

As shown in FIG. 6, the computing system 600 can include a processor 610, a memory 620, a storage device 630, and input/output devices 640. The processor 610, the memory 620, the storage device 630, and the input/output devices 640 can be interconnected via a system bus 650. The processor 610 is capable of processing instructions for execution within the computing system 600. Such executed instructions can implement one or more components of, for example, the client device 115, the knowledge graph service 120, the natural language processing engine 130, and/or the enterprise backend 140. In some implementations of the current subject matter, the processor 610 can be a single-threaded processor. Alternately, the processor 610 can be a multi-threaded processor. The processor 610 is capable of processing instructions stored in the memory 620 and/or on the storage device 630 to display graphical information for a user interface provided via the input/output device 640.

The memory 620 is a computer readable medium such as volatile or non-volatile that stores information within the computing system 600. The memory 620 can store data structures representing configuration object databases, for example. The storage device 630 is capable of providing persistent storage for the computing system 600. The storage device 630 can be a floppy disk device, a hard disk device, an optical disk device, or a tape device, or other suitable persistent storage means. The input/output device 640 provides input/output operations for the computing system 600. In some implementations of the current subject matter, the input/output device 640 includes a keyboard and/or pointing device. In various implementations, the input/output device 640 includes a display unit for displaying graphical user interfaces.

According to some implementations of the current subject matter, the input/output device 640 can provide input/output operations for a network device. For example, the input/output device 640 can include Ethernet ports or other networking ports to communicate with one or more wired and/or wireless networks (e.g., a local area network (LAN), a wide area network (WAN), the Internet).

In some implementations of the current subject matter, the computing system 600 can be used to execute various interactive computer software applications that can be used for organization, analysis and/or storage of data in various (e.g., tabular) format (e.g., Microsoft Excel®, and/or any other type of software). Alternatively, the computing system 600 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities (e.g., SAP Integrated Business Planning add-in for Microsoft Excel as part of the SAP Business Suite, as provided by SAP SE, Walldorf, Germany) or can be standalone computing products and/or functionalities. Upon activation within the applications, the functionalities can be used to generate the user interface provided via the input/output device 640. The user interface can be generated and presented to a user by the computing system 600 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

What is claimed is:

1. A system, comprising:
at least one data processor; and
at least one memory storing instructions which, when executed by the at least one data processor, result in operations comprising:
in response to receiving a natural language command invoking a workflow of an enterprise software application, parsing the natural language command to identify at a first entity associated with a first value included in the natural language command;
determining, based at least on a knowledge graph representative of an ontology associated with the enterprise software application, a second entity related to the first entity; and
generating a first request for the enterprise software application execute the workflow based at least on the first value of the first entity and a second value of the second entity.

2. The system of claim 1, wherein the operations further comprise:
upon determining that the second value of the second entity is absent from the natural language command, generating a second request for the second value; and
in response to receiving the second value, generating the first request for the enterprise software application to execute the workflow.

3. The system of claim 1, wherein the parsing of the natural language command is performed by applying a rule-based natural language processing technique.

4. The system of claim 1, wherein the parsing of the natural language command is performed by applying a machine learning model.

5. The system of claim 4, wherein the operation further comprise:
generating, based at least on the knowledge graph, training data for training the machine learning model.

6. The system of claim 5, wherein the generating of the training data includes traversing the knowledge graph to identify the first entity and the second entity related to the first entity, and slot filling a query template by at least inserting a first value into a first slot corresponding to the first entity and a second value into a second slot corresponding to the second entity.

7. The system of claim 4, wherein the machine learning model comprises a linear model, a decision tree, an ensemble method, a support vector machine, a Bayesian model, a deep neural network, a deep belief network, a recurrent neural network, and/or a convolutional neural network.

8. The system of claim 1, wherein the ontology defines a relationship between the first entity and the second entity, and wherein the knowledge graph represents the relationship between the first entity and the second entity by at least including a first node corresponding to the first entity being connected by a directed edge to a second node corresponding to the second entity.

9. The system of claim 8, wherein the first entity corresponds to the enterprise workflow, and wherein the second entity corresponds to a first operation that is performed in order to execute the enterprise workflow.

10. The system of claim 9, wherein the knowledge graph further includes a third node corresponding to a third entity related to the first entity and/or the second entity, and wherein the third entity comprises a second operation that is performed in order to execute the enterprise workflow.

11. A computer-implemented method, comprising:
in response to receiving a natural language command invoking a workflow of an enterprise software application, parsing the natural language command to identify at a first entity associated with a first value included in the natural language command;
determining, based at least on a knowledge graph representative of an ontology associated with the enterprise software application, a second entity related to the first entity; and
generating a first request for the enterprise software application execute the workflow based at least on the first value of the first entity and a second value of the second entity.

12. The method of claim 11, further comprising:
upon determining that the second value of the second entity is absent from the natural language command, generating a second request for the second value; and
in response to receiving the second value, generating the first request for the enterprise software application to execute the workflow.

13. The method of claim 11, wherein the parsing of the natural language command is performed by applying a rule-based natural language processing technique.

14. The method of claim 11, wherein the parsing of the natural language command is performed by applying a machine learning model.

15. The method of claim 14, further comprising:
generating, based at least on the knowledge graph, training data for training the machine learning model.

16. The method of claim 15, wherein the generating of the training data includes traversing the knowledge graph to identify the first entity and the second entity related to the first entity, and slot filling a query template by at least inserting a first value into a first slot corresponding to the first entity and a second value into a second slot corresponding to the second entity.

17. The method of claim 14, wherein the machine learning model comprises a linear model, a decision tree, an ensemble method, a support vector machine, a Bayesian model, a deep neural network, a deep belief network, a recurrent neural network, and/or a convolutional neural network.

18. The method of claim 11, wherein the ontology defines a relationship between the first entity and the second entity, wherein the knowledge graph represents the relationship between the first entity and the second entity by at least including a first node corresponding to the first entity being connected by a directed edge to a second node corresponding to the second entity, wherein the first entity corresponds to the enterprise workflow, and wherein the second entity corresponds to a first operation that is performed in order to execute the enterprise workflow.

19. The method of claim 19, wherein the knowledge graph further includes a third node corresponding to a third entity related to the first entity and/or the second entity, and wherein the third entity comprises a second operation that is performed in order to execute the enterprise workflow.

20. A non-transitory computer readable medium storing instructions, which when executed by at least one data processor, result in operations comprising:
in response to receiving a natural language command invoking a workflow of an enterprise software application, parsing the natural language command to identify at a first entity associated with a first value included in the natural language command;
determining, based at least on a knowledge graph representative of an ontology associated with the enterprise software application, a second entity related to the first entity; and
generating a first request for the enterprise software application execute the workflow based at least on the first value of the first entity and a second value of the second entity.
